(19) United States
(12) Patent Application Publication
(10) Pub. No.: US 2016/0131295 A1
(43) Pub. Date: May 12, 2016

(54) A METHOD OF MANUFACTURING AN ELBOW CHANNEL AND AN ELBOW CHANNEL

(71) Applicant: OUTOTEC (FINLAND) OY, Espoo (FI)

(72) Inventors: Jussi VAARNO, Sundsberg (FI); Rami SAARIO, Espoo (FI); Henri FREDRIKSSON, Helsinki (FI)

(73) Assignee: OUTOTEC (FINLAND) OY, Espoo, OT (FI)

(21) Appl. No.: 14/896,034

(22) PCT Filed: May 28, 2014
(86) PCT No.: PCT/FI2014/050422

§ 371 Date: Dec. 4, 2015

(30) Foreign Application Priority Data
Jun. 10, 2013 (FI) 20135633

(51) Int. Cl. F16L 43/00; B29C 65/00; B29C 53/56

(52) U.S. Cl. CPC F16L 43/008; B29C 53/56; B29C 66/11; B29C 66/52231; B29L 2031/243

(57) ABSTRACT

A method of manufacturing an elbow channel with an elbow angle. The method comprises manufacturing an elongated filament-reinforced plastic composite hollow body by a filament winding technology; miter-cutting the elongated hollow body at a cut angle, which is half of the desired elbow angle, to form a first body piece having an oblique first end, and a second body piece having an oblique second end; placing the first body piece and the second body piece in relation to each other to abut the first end and the second end against each other, so that the longitudinal symmetry axes of the first and second body pieces are at said elbow angle to each other; and attaching the first end and the second end to each other to form said elbow channel. The elbow channel is formed from first and second hollow body pieces is also provided.

### FIELD OF THE INVENTION

The present invention relates to a method of manufacturing an elbow channel with an elbow angle. Further, the invention relates to an elbow channel with an elbow angle.

### BACKGROUND OF THE INVENTION

In prior art documents U.S. Pat. No. 6,176,608, U.S. Pat. No. 5,662,871 and U.S. Pat. No. 6,267,900 there are disclosed elbow channels, such as a dispersion uptake shaft and outlet weir box (also commonly called as an outlet box) which are used in connection with hydrometallurgical liquid-liquid solvent extraction settlers. An elbow channel comprises channel parts which are at an angle to each other. Such elbow channel structures are traditionally manufactured as fiber-reinforced composite structures by hand lamination on a complicated hand-carved wooden mould. This kind of fabrication method is slow, cumbersome, time-consuming and costly. The manual fabrication method is also susceptible to quality variations depending on skills of the person making the lamination work. The mould can be used only once and it becomes waste after the elbow channel has been manufactured.

### OBJECTIVE OF THE INVENTION

The objective of the invention is to eliminate the disadvantages mentioned above.

In particular, it is an object of the present invention to provide a method which reduces manufacturing costs and simplifies and expedites the manufacturing process of the elbow channel.

It is also an object of the present invention to provide a method in which the mould to be used in manufacturing can be repeatedly used.

Further, it is an object of the present invention to provide an elbow channel which is cheaper than the hand laminated elbow channel and has reduced manufacturing costs.

### SUMMARY OF THE INVENTION

According to a first aspect, the present invention provides a method of manufacturing an elbow channel with an elbow angle, the elbow channel being a filament-reinforced plastic composite structure. In accordance with the invention, the method comprises the steps of:
manufacturing an elongated filament-reinforced plastic composite hollow body by a filament winding technology,
miter-cutting the elongated hollow body at a cut angle, which is half of the desired elbow angle, to form a first body piece having an oblique first end and a second body piece having an oblique second end,
placing the first body piece and the second body piece in relation to each other to abut the first end and the second end against each other, so that the longitudinal symmetry axes of the first and second body pieces are at said elbow angle to each other, and
attaching the first end and the second end to each other to form said elbow channel.

According to a second aspect, the present invention provides an elbow channel with an elbow angle, the elbow channel being a filament-reinforced plastic composite structure. In accordance with the invention, the elbow channel is formed from first and second hollow body pieces which are miter cut at a cut angle, which is half of the desired elbow angle, from an elongated filament-wound filament-reinforced plastic composite hollow body and said hollow body pieces being connected to each other at their miter cut oblique first and second ends to form said elbow channel.

The advantage of the invention is that the manufacturing time, cost of the elbow channel is reduced and the quality is improved. The mandrel used as a mould in the filament winding process can be used repeatedly no mould waste being generated from it.

In one embodiment of the method, the elongated hollow body is formed by the filament winding technology with the steps of:
arranging an elongated mandrel the outside diameter of which corresponds to the inside diameter of the elongated hollow body to be formed, an
rotating the mandrel and simultaneously winding resin-impregnated filament in a number of layers around and on the rotary mandrel to form the hollow body with a desired wall thickness,
curing the hollow body on the mandrel, and
removing the cured hollow body from the mandrel.

In one embodiment of the method, the first end and the second end are laminated to each other.

In one embodiment of the method, the method comprises arranging an opening to the wall of the elbow channel.

In one embodiment of the method, the method comprises attaching a closure at an end of the elbow channel.

In one embodiment of the method, the method comprises steps of:
manufacturing an elongated filament reinforced plastic composite second hollow body by a filament winding technology to form a launder for a liquid-liquid solvent extraction settler, so that the second hollow body has a total length which exceeds the first length of the launder at least by the second length of the hollow body, and
cross-cutting the second elongated hollow body to form the launder with the first length and the hollow body with the second length, from which hollow body said elbow channel is formed.

In one embodiment of the method, the elbow channel is a dispersion uptake shaft of a feed launder which is for feeding a dispersion to a liquid-liquid solvent extraction settler.

In one embodiment of the method, the elbow channel is an outlet box of a discharge launder to receive a separated solution phase which is discharged from a liquid-liquid solvent extraction settler.

In one embodiment of the method, the elbow angle is 90° or acute angle or obtuse angle.

In one embodiment of the elbow channel, the elbow angle is 90° or acute angle or obtuse angle.

In one embodiment of the elbow channel, the elbow channel is a dispersion uptake shaft of a feed launder which is for feeding the dispersion to a liquid-liquid solvent extraction settler.

In one embodiment of the elbow channel, the elbow channel is an outlet box of a discharge launder to receive a separated solution phase which is discharged from a liquid-liquid solvent extraction settler.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a schematic illustration of the step of filament winding a hollow body for forming the elbow channel in accordance with an embodiment of the method of the invention,

FIG. 2 shows the cured hollow body detached from the mandrel,

FIG. 3 shows the hollow body after being miter cut to a first and a second hollow body piece,

FIG. 4 shows the elbow channel formed of the miter cut first and second hollow body piece being attached to each other,

FIG. 5 shows the elbow channel after being equipped with a closure and two openings,

FIG. 6 shows a schematic plan view of a solvent extraction settler arrangement having elbow channels formed to a dispersion uptake shaft and outlet boxes,

FIG. 7 is a cross-section VII-VII of FIG. 6 showing a dispersion feed launder and an elbow channel formed to a dispersion uptake shaft manufactured according to an embodiment of the method of the invention,

FIG. 8 is a cross-section VIII-VII of FIG. 6 showing a discharge launder and an elbow channel formed as an outlet box manufactured according to an embodiment of the method of the invention, and

FIG. 9 shows a filament wound second hollow body from which a launder and a hollow body for an elbow channel can be cut.

### DETAILED DESCRIPTION OF THE INVENTION

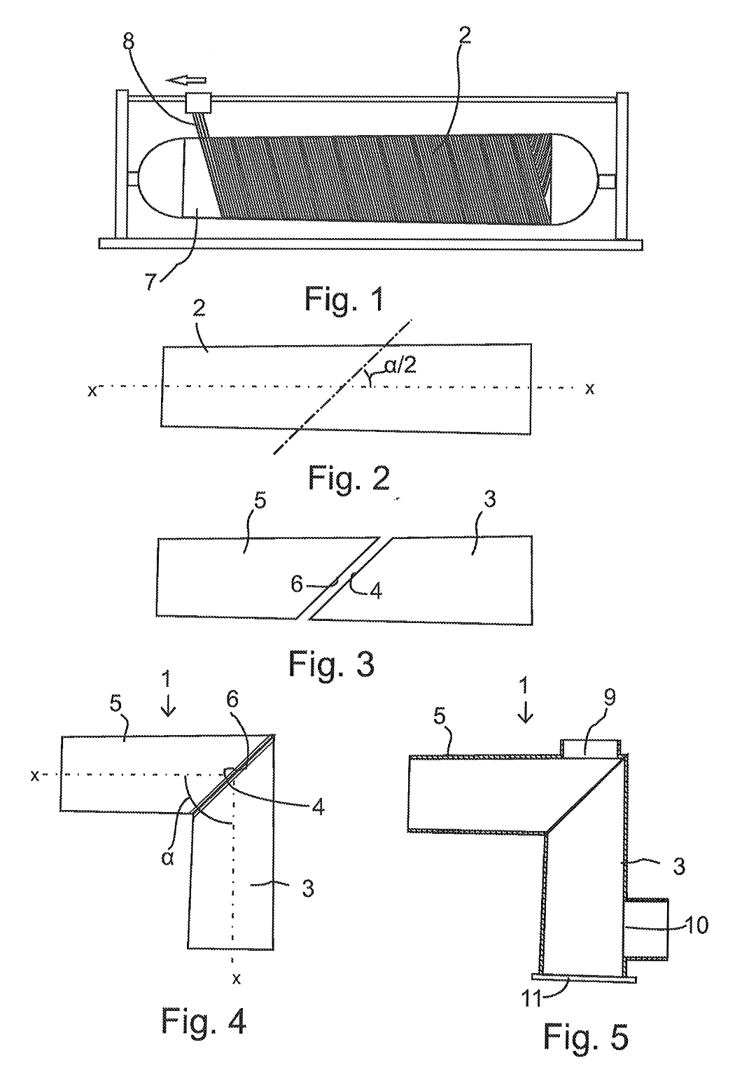

FIGS. 1 to 5 show different steps of manufacturing an elbow channel 1 having an elbow angle a.

An elongated filament-reinforced plastic composite hollow body 2 is formed by a filament winding process, as shown in FIG. 1. An elongated mandrel 7 is arranged. The outside diameter of the mandrel 7 is dimensioned so that it corresponds to the inside diameter of the elongated hollow body 2 to be formed. The mandrel 7 is rotated and simultaneously resin-impregnated filament 8 is wound in a number of layers on the rotating mandrel 7 to form the hollow body 2 with a desired wall thickness. After the winding process is completed, the resin of the hollow body 2 is cured while the hollow body is still on the mandrel 7. After the resin in the hollow body 2 has been cured, the hollow body 2 is removed from the mandrel 7.

FIGS. 2 and 3 show miter-cutting of the elongated hollow body 2 along a plane which is at a cut angle α/2, which is half of the desired elbow angle α, to form a first body piece 3, which has an oblique first end 4, and a second body piece 5 which has having an oblique second end 6. In the illustrated example the elbow angle α is 90° and therefore the cut angle is 45°. In other not-shown embodiments the elbow angle α can be different than 90°, i.e. it can be an obtuse angle or an acute angle, as desired.

As shown in FIG. 4, the first body piece 3 and the second body piece 5 are placed in relation to each other so that the first end 4 of the first hollow piece 3 and the second end 6 of the second hollow piece are abutting against each other, so that the longitudinal symmetry axes x of the first and second body pieces are at the elbow angle 90° to each other. The first end 4 and the second end 6 are attached to each other to form the elbow channel 1. The attachment of can be made e.g. by laminating.

FIG. 5 shows an example of an elbow channel 1 which is configured to include a closure 11 at the lower end of the first hollow piece 3. An opening 9 that enables access to the inner space of the elbow channel 1 (for e.g. sampling purposes) is arranged on top of the second hollow piece 5 at a location above a vertical shaft which is formed by the inner space of the first hollow piece 3. Another opening 10 which opens laterally is arranged in the wall of the first hollow piece to form an inlet to the inner space of the elbow channel 1, or alternatively to form an outlet from the inner space of the elbow channel, depending of the direction of the flow of the fluid which is to be conducted through the elbow channel 1.

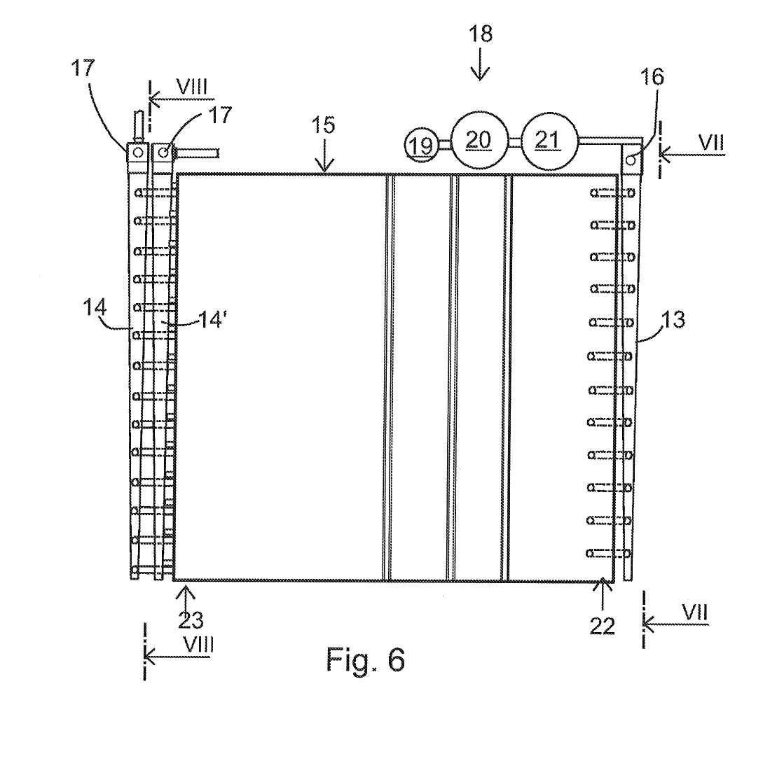

FIG. 6 shows a solvent extraction settler arrangement which is adapted for hydrometallurgical liquid-liquid solvent extraction processes. The arrangement comprises a pump/mixing unit 18 and a solvent extraction settler 15. The pump/mixing unit 18 includes, in this case, a pumping unit 19 and two mixers 20, 21. Two or more liquid phases that are insoluble in each other are mixed together into a dispersion in the pump 19. Pump 19 feeds the dispersion to mixer 20, from where it is routed on to the second mixer 21 and from thereon via a dispersion uptake shaft 16 to a feed launder 13 arranged along and beside the feed end 22. The dispersion feed launder 16 distributes the dispersion to the solvent extraction settler tank 15. The phases to be mixed into a dispersion in the arrangement may be a heavy solution, for instance an aqueous solution, and a light solution, for instance an organic solution. In dispersion the extraction reaction transfers for example metals from one phase to the other. The solution phases are separated by gravity from each other in the settler tank while they flow to a discharge end 23 of the settler tank 15. From the discharge end 23 the heavy solution phase flows as an underflow to the discharge launder 14, and the light solution phase flows as an overflow another discharge launder 14′. In the launders 14, 14′ flow to one end of each discharge launder and further through the outlet boxes 17 which are arranged at the ends of the discharge launders to receive the solution phases.

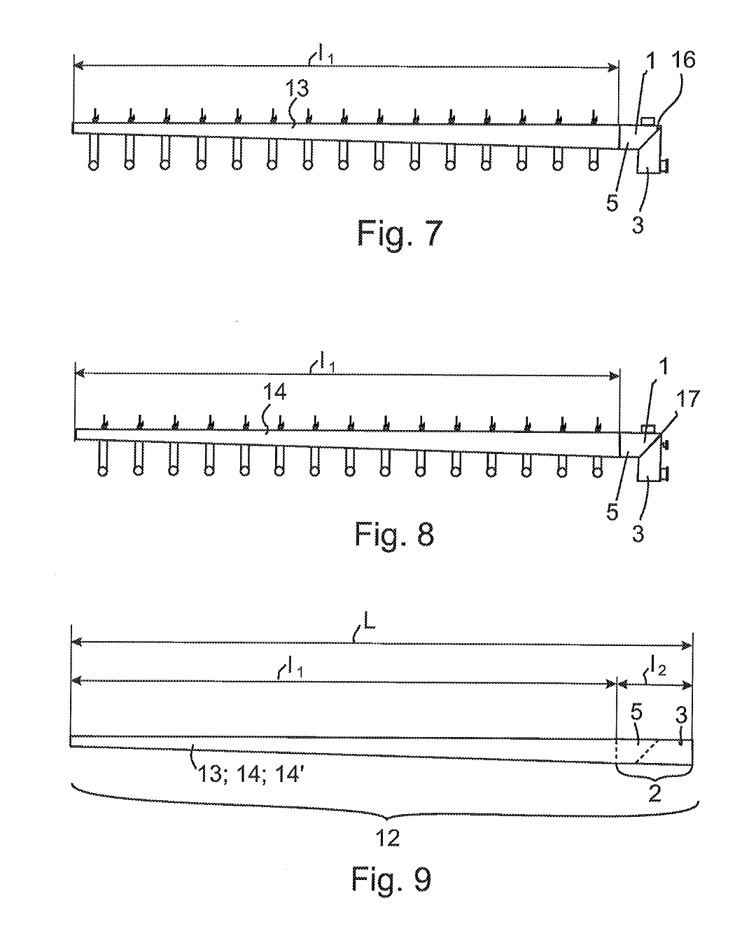

FIG. 7 shows the dispersion feed launder 13 and the dispersion uptake shaft 16 connected to it. Figure shows the discharge launder 14 and the outlet box 17 connected to it. The launders 13, 14 are tubular and can be manufactured by filament winding. Both the dispersion uptake shaft 16 and the outlet box 17 can be manufactured simultaneously with the launders 13, 14.

As shown in FIG. 9, an elongated filament-reinforced plastic composite second hollow body 12 is manufactures by a filament winding technology, in a manner as disclosed in connection with FIG. 1, to form a launder 13, 14, 14′ so that the second hollow body 12 has a total length L which exceeds the first length l₁ of the launder 13, 14, 14′ at least by the second length l₂ of the hollow body 2. FIG. 2 shows a cured second hollow body 12. The second elongated hollow body 12 is cross-cut to form a part which forms the launder 13, 14, 14′ with the first length l₁ and another part which forms the hollow body 2 with the second length l₂. The elbow channel 1 is formed from the hollow body 2 to make a dispersion uptake shaft 16 or an outlet box 17, in a manner as disclosed above with reference to FIGS. 2 to 5.

Although the method and the elbow channel have been described in connection with a solvent extraction settler, it should be understood that the method and the elbow channel are not so limited. Any elbow channel which is intended to conduct fluid, either in a form of liquid or gas, can be manufactured with the described method. While the present inventions have been described in connection with a number of exemplary embodiments, and implementations, the present inventions are not so limited, but rather cover various modifications, and equivalent arrangements, which fall within the purview of prospective claims.

1. A method of manufacturing an elbow channel with an elbow angle (α), the elbow channel being a filament-reinforced plastic composite structure, wherein the method comprises the steps of:
manufacturing an elongated filament-reinforced plastic composite hollow body by a filament winding technology,
miter-cutting the elongated hollow body at a cut angle (α/2), which is half of the desired elbow angle (α), to form a first body piece having an oblique first end, and a second body piece having an oblique second end,
placing the first body piece and the second body piece in relation to each other to abut the first end and the second end against each other, so that the longitudinal symmetry axes (x) of the first and second body pieces are at said elbow angle (α) to each other, and
attaching the first end and the second end to each other to form said elbow channel.

2. The method according to claim 1, wherein the elongated hollow body is formed by the filament winding technology with the steps of:
arranging an elongated mandrel the outside diameter of which corresponds to the inside diameter of the elongated hollow body to be formed,
rotating the mandrel and simultaneously winding resin-impregnated filament in a number of layers around and on the rotary mandrel to form the hollow body with a desired wall thickness,
curing the hollow body on the mandrel, and
removing the cured hollow body from the mandrel.

3. The method according to claim 1, wherein the first end and the second end are laminated to each other.

4. The method according to claim 1, wherein the method comprises arranging an opening to the wall of the elbow channel.

5. The method according to claim 1, wherein the method comprises attaching a closure at an end of the elbow channel.

6. The method according to claim 1, wherein the method comprises steps of:
manufacturing an elongated filament-reinforced plastic composite second hollow body by a filament winding technology to form a launder for a liquid-liquid solvent extraction settler so that the second hollow body has a total length (L) which exceeds the first length (1₂) of the launder at least by the second length (1₂) of the hollow body, and
cross-cutting the second elongated hollow body to form the launder with the first length (li) and the hollow body (2) with the second length (l2), from which hollow body said elbow channel is formed.

7. The method according to claim 1, wherein the elbow channel is a dispersion uptake shaft of a dispersion feed launder which is for feeding a dispersion to a liquid-liquid solvent extraction settler.

8. The method according to claim 1, wherein the elbow channel is an outlet box of a discharge launder to receive a separated solution phase which is discharged from a liquid-liquid solvent extraction settler.

9. The method according to claim 1, wherein the elbow angle (α) is 90° or acute angle or obtuse angle.

10. An elbow channel with an elbow angle (α), the elbow channel being a filament-reinforced plastic composite structure, wherein the elbow channel is formed from first and second hollow body pieces which are miter cut at a cut angle (α/2) from an elongated filament-wound filament-reinforced plastic composite hollow body, and said hollow body pieces being connected to each other at their miter cut oblique first and second ends to form said elbow channel.

11. The elbow channel according to claim 10, wherein the elbow angle (α) is 90° or acute angle or obtuse angle.

12. The elbow channel according to claim 10, wherein the elbow channel is a dispersion uptake shaft of a feed launder which is for feeding a dispersion to a liquid-liquid solvent extraction settler.

13. The elbow channel according to claim 10, wherein the elbow channel is an outlet box of a discharge launder to receive a separated solution phase which is discharged from a liquid-liquid solvent extraction settler.
